(19) United States
(12) Patent Application Publication
(10) Pub. No.: US 2011/0008048 A1
(43) Pub. Date: Jan. 13, 2011

(54) Optical system using optical signal and solid state drive module using the optical signal

(75) Inventors: Yong-hoon Kim, Suwon-si (KR); Hee-Seok Lee, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/662,674

(22) Filed: Apr. 28, 2010

(30) Foreign Application Priority Data
Jul. 9, 2009 (KR) 10-2009-0062565

(51) Int. Cl. H04B 10/00; H04J 14/02

(52) U.S. Cl. 398/79; 398/115

(57) ABSTRACT

An optical system and an SSD module that maintain optimal SI, PI and EMI characteristics without a shield based on a ground voltage and an impedance match. The optical system includes a solid state drive (SSD) module and an input/output (I/O) interface. The SSD module includes a plurality of solid state memory units. The input/output (I/O) interface receives data to be written to at least one of the solid state memory units from a main memory unit, the input/output (I/O) interface transmits data written in at least one of the solid state memory units to the main memory unit. The SSD module and the I/O interface transmit and receive data using an optical medium.

### CROSS-REFERENCE TO RELATED APPLICATIONS

This application claims the benefit of Korean Patent Application No. 10-2009-0062565, filed on Jul. 9, 2009, in the Korean Intellectual Property Office, the disclosure of which is incorporated herein in its entirety by reference.

### BACKGROUND

1. Field

Example embodiments of the inventive concepts relate to optical systems, and more particularly, to an optical system transmitting/receiving data using optical signals.

2. Description of the Related Art

If a plurality of segments of data are transmitted/received in parallel, a large amount of data may be transmitted/received rapidly. However, the number of transmission/reception lines increases and the overall system is complicated. Recently, a scheme of transmitting/receiving a plurality of data in series has been used to overcome the aforementioned limitation of the parallel data transmission. A serial data transmission/reception scheme has a relatively higher data rate as compared to the parallel data transmission/reception scheme. As the transmission rate of transmitted/received data increases, the rate of transmitted/received signals must be considered in designing not only a chip associated with the system but also a package of the chip and a board mounting electrical devices, e.g., chips, resistors and condensers.

However, if the package and the board are implemented in the optimal state, to fundamentally prevent Signal Integrity (SI), Power Integrity (PI) and Electro-Magnetic Interference (EMI) that are generated on a set level may prove difficult. Further, a strip line or a micro strip line is used to transmit high-rate electrical signals. However, cross talk between transmission lines and an electromagnetic wave emitted from each transmission cannot be prevented if the package and the board are optimized. This problem becomes more serious as the signal transmission rate increases.

A technique of using two differential lines to transmit signals having different polarities or a voltage difference and a technique of reducing the impedance matching of an interface and the cross talk between signals have been used to achieve the SI, PI and EMI characteristics. However, even if these techniques are used, if a data transmission/reception rate becomes higher than 10 Gbps (Giga bit per second), satisfying the electrical characteristics required with respect to the SI, PI and EMI remains difficult.

A solid state drive or a solid state disk (SSD) drive performs the same function as a hard disk drive (HDD), however the SSD stores data by using a semiconductor memory device unlike the HDD. The SSD is suitable for small size and lightweight applications because the SSD provides a high data input/output rate, protects data against an external impact, has low heat generation, low noise and low power consumption.

Memory devices such as DDR SDRAM and NAND flash memory are connected to an SSD controller of an SSD module. A DDR SDRAM has a complicated connection structure because the DDR SDRAM has a large number of signal input/output pins. In the case of DDR SDRAM pins, a ground line must be provided close to the pins in order to maintain the impedance matching and prevent the signal interference between the pins. However, if the number of DDR SDRAM pins increases, the number of board layers increases, thus increasing the costs. For DDR2, a data rate is 667 Mbps' (Mega bit per second). However, for DDR3, a data rate increases to 1666 Mbps. Therefore, increasing only the number of board layers is insufficient to satisfy the electrical characteristics of the SI, PI and EMI.

If an SSD module includes memory devices having an increased number of data transmission pins and an increased transmission rate of data associated with each pin, the SSD module needs to satisfy the electrical conditions for the SI, PI and EMI when it communicates data with the system and when its SSD controller and memory devices communicate data with each other.

### SUMMARY

Example embodiments of the inventive concept provide an optical system that maintains optimal SI, PI and EMI characteristics without considering a shield based on a ground voltage and an impedance match.

Example embodiments of the inventive concept also provide an SSD module that maintains optimal SI, PI and EMI characteristics without considering a shield based on a ground voltage and an impedance match.

According to an example embodiment of the inventive concept, there is provided an optical system including a solid state drive (SSD) module and an input/output (I/O) interface. The SSD module includes a plurality of solid state memory units. The input/output (I/O) interface receives data to be written to at least one of the solid state memory units from a main memory unit, the input/output (I/O) interface transmits data written in at least one of the solid state memory units to the main memory unit. The solid state drive (SSD) module and the I/O interface transmit and receive data by using an optical medium (e.g., an optical fiber or an optical waveguide).

According to another example embodiment of the inventive concept, there is provided a solid state drive (SSD) module including solid state memory units, a control unit and a signal conversion unit. The control unit controls the solid state memory units. The signal conversion unit converts an optical signal, received from the control unit through the optical medium (e.g., an optical fiber or an optical waveguide), into an electrical signal prior to transfer to the solid state memory units. The signal conversion unit converts an electrical signal, received from the solid state memory units, into an optical signal prior to transfer to the control unit through the optical medium (e.g., an optical fiber or an optical waveguide). The signal conversion unit transfers an optical signal through the signal conversion unit.

According to another example embodiment of the inventive concept, a control unit includes a first converter, a second converter, a switch, a third converter and a fourth converter. The first converter converts a first differential signal into a first electrical signal. The second converter converts the first electrical signal into a first optical signal. The switch transfers the first optical signal to an optical medium and receives a second optical signal from the optical medium. The third converter converts the second optical signal into a second electrical signal. The fourth converter converts the second electrical signal into a second differential signal.

The optical system and the solid state drive (SSD) module may maintain an optimal SI, PI and EMI characteristics without considering a shield based on a ground voltage and an impedance match.

### BRIEF DESCRIPTION OF THE DRAWINGS

Example embodiments of the inventive concept will be more clearly understood from the following detailed description taken in conjunction with the accompanying drawings in which:

FIG. 1 illustrates an optical system according to example embodiments of the inventive concept;

FIG. 2 illustrates an SSD module according to example embodiments of the inventive concept; and

FIG. 3 illustrates an Optical Add/Drop Multiplexer (OADM) of FIG. 2.

FIG. 4 is a schematic diagram roughly illustrating a memory card 400 according to example embodiments; and

FIG. 5 is a block diagram roughly illustrating an electronic system 500 according to example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

Example embodiments of the inventive concept will now be described more fully with reference to the accompanying drawings, in which example embodiments of the inventive concept are shown. Example embodiments of the inventive concept may, however, be embodied in many different forms and should not be construed as being limited to the embodiments set forth herein; rather, these embodiments are provided so that this disclosure will be thorough and complete, and will fully convey the concept of the example embodiments of the inventive concept to those skilled in the art. In the drawings, like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Example embodiments of the inventive concept may transmit/receive signals using optical devices instead of electrical devices, thereby maintaining the optimal SI, PI and EMI characteristics without considering a shield based on a ground voltage and an impedance match.

Further, example embodiments of the inventive concept may use a Wavelength Division Multiplex (WDM) technique for transmitted/received signals to form a plurality of channels in one transmission line.

The terms used in the example embodiments inventive concept will be briefly described below. Integrated Drive Electronics (IDE) interfaces may be interfaces of a hard disk drive/optical disk drive (ODD) supported by a main board. Advanced Technology Attachment (ATA) is the standards by which memory devices (e.g., hard disk drives and CD-ROM drives) access an IDE interface in a personal computer. ATA devices are classified into parallel ATA (PATA) and serial ATA (SATA). PATA transmits/receives a plurality of data in parallel through a plurality of cables, and PATA transmits/receives data in series through a small number of cables. SATA has a relatively higher data rate as compared to PATA. Until the introduction of the SATA, a 40-pin ribbon cable was used to connect the disk drive.

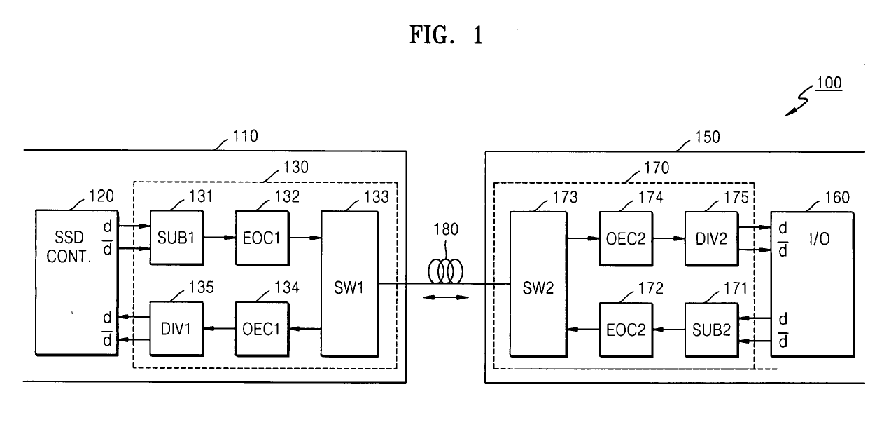

FIG. 1 illustrates an optical system according to example embodiments of the inventive concept. Referring to FIG. 1, an optical system 100 includes an SSD module 110 and an input/output (I/O) interface 150.

The SSD module 110 may include a plurality of solid state memory devices (not illustrated). A hard disk module may mechanically read or search data written on a hard disk, whereas the SSD module 110 may mechanically perform the same. The difference is well known by those skilled in the art, and thus further description will be omitted for conciseness.

The SSD module 110, storing large-capacity data, may be configured to input/output data via optical communication with a main control unit (not illustrated) that requests data. The I/O interface 150 may be configured to receive/transmit data, that may be written in a memory device, from/to the main control unit.

The SSD module 110 and the I/O interface 150 may use an optical medium (e.g., an optical fiber or an optical waveguide) to transmit/receive data. Because the conventional methods use a strip line or a micro strip line, the conventional methods have performance problems caused by the electromagnetic waves generated from a signal interference line between transmission lines. However, example embodiments of the inventive concept may not have performance problems because example embodiments of the invention concept may use an optical medium (e.g., an optical fiber or an optical waveguide). Among the signal lines illustrated in FIG. 1, a signal line denoted by three overlapping circles is an optical medium (e.g., an optical fiber or an optical waveguide) and the other signal lines are metal lines.

The SSD module 110 may include a SSD control unit 120 and a first conversion unit 130. The SSD control unit 120 may be configured to write/read data in/from a memory device (not illustrated). Data may be input/output to/from the SSD control unit 120 according to a differential signal scheme, that may be represented by two differential signals d and d having different voltage levels or a voltage difference.

The first conversion unit 130 may convert first differential electrical signals d and d, received from the SSD control unit 120, into a first optical signal, and may transmit the first optical signal to an optical medium 180 (e.g., an optical fiber or an optical waveguide). The first conversion unit 130 may convert a second optical signal, received from an optical medium 180, into second differential electrical signals d and d, and may transfer the second differential electrical signals d and d to the SSD control unit 120.

The first conversion unit 130 may include a first electrical signal converter 131, a first electrical-to-optical signal converter 132, a first switch 133, a first optical-to-electrical signal converter 134, and a second electrical signal converter 135. The first electrical signal converter 131 may convert a first differential electrical signal into a first electrical signal. The first electrical-to-optical signal converter 132 may convert a first electrical signal into a first optical signal. The first switch 133 may transfer the first optical signal to the optical medium 180 and may receive the second optical signal. The first optical-to-electrical signal converter 134 may convert a second optical signal into a second electrical signal. The second electrical signal converter 135 may convert a second electrical signal into a second differential electrical signal.

The I/O interface 150 may include an I/O control unit 160 and a second conversion unit 170. The I/O control unit 160 may transfer a data signal from the main control unit to the second conversion unit 170, and may transmit a data signal from the second conversion unit 170 to the main control unit.

The second conversion unit 170 may convert second differential electrical signals d and d, received from the main control unit, into a second optical signal, and may transmit the second optical signal to an optical medium 180. The second conversion unit 170 may convert a first optical signal, received from the optical medium 180, into first differential electrical signals d and d, and may transfer the first differential electrical signals d and d to the main control unit.

The second conversion unit 170 may include a third electrical signal converter 171, a second electrical-to-optical signal converter 172, a second switch 173, a second optical-to-electrical signal converter 174, and a fourth electrical signal converter 175. The third electrical signal converter 171 may convert a second differential electrical signal into a second electrical signal. The second electrical-to-optical signal converter 172 may convert a second electrical signal into a second optical signal. The second switch 173 may transfer a second optical signal to the optical medium 180 and receives a second optical signal from the optical medium 180. The second optical-to-electrical signal converter 174 may convert a first optical signal into a first electrical signal. The fourth electrical signal converter 175 may convert a first electrical signal into a first differential electrical signal and may transfer the first differential electrical signal to the I/O control unit 160.

The first electrical-to-optical signal converter 132 and the second electrical-to-optical signal converter 172 may be implemented using photo detectors, and the first optical-to-electrical signal converter 134 and the second optical-to-electrical signal converter 174 may be implemented using laser diodes.

The data transmitted/received through the optical medium 180 used in example embodiments of the inventive concept may be suitable for transmission of high-rate signals pursuant to the SATA standards. For example, the data may be transmitted in, for example a WDM technique.

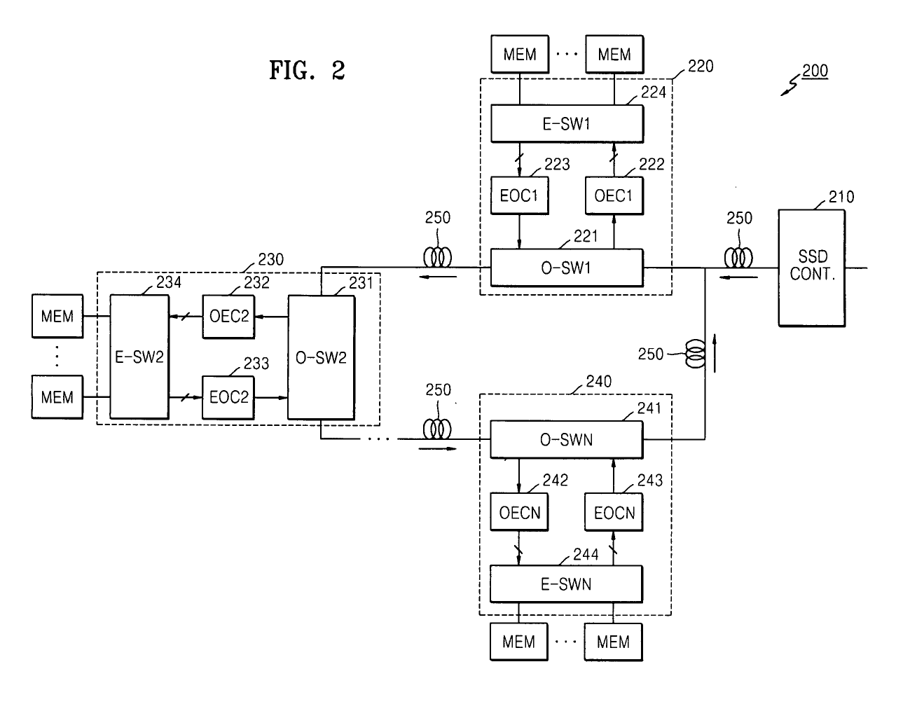

FIG. 2 illustrates an SSD module according to example embodiments of the inventive concept. Referring to FIG. 2, an SSD module 200 may include solid state memory units MEM, a control unit 210, and signal conversion units 220-240.

The control unit 210 may interface between the SSD module 200 and an external system. The control unit 210 may control an operation of each solid state memory unit MEM so that data is written/read into/from each solid state memory unit MEM.

Each of the signal conversion units 220-240 may convert an optical signal, received from the control unit 210 via an optical medium 250 (e.g., an optical fiber or an optical waveguide), into an electrical signal and may transfer the electrical signal to each of the solid state memory units MEM. Each of the signal conversion units 220-240 may convert an electrical signal, received from each of the solid state memory units MEM, into an optical signal and may transfer the optical signal to the control unit 210 via the optical medium 250 or bypasses an optical signal loaded in an optical medium 250.

Although FIG. 2 illustrates that the SSD module 200 may include a plurality of signal conversion units 220-240, the SSD module 200 may use only one signal conversion unit 220 according to example embodiments of the invention concept. Because the signal conversion units 220-240 have the same internal structure, only the N^{th} (N being an integer value) signal conversion unit 240 is described herein.

The N^{th} signal conversion unit 240 includes an optical signal switch 241, an optical-to-electrical signal converter 242, an electrical-to-optical converter 243, and an electrical signal switch 244.

The electrical signal switch 244 may switch a first signal stored in the solid state memory units MEM or a second signal to be stored in the solid state memory unit MEM. The electrical-to-optical signal converter 243 may convert a voltage-type or current type first signal into a light-type first optical signal. The optical signal switch 241 may transfer a first optical signal to the optical medium 250, may receive a second optical signal from the optical medium 250, or may bypass an optical signal present in the optical medium 250. The optical signal switch 241 may be implemented using, for example an Optical Add/Drop Multiplexer (OADM). The optical-to-electrical signal converter 242 may convert a light-type second optical signal into a voltage-type or a current-type second signal.

As indicated above, the signal conversion units 220-240 have the same internal structure. Therefore, one skilled in the art will recognize that the internal elements of signal conversion unit 220 (elements 221, 222, 223 and 224) and the internal elements of signal conversion unit 230 (elements 231, 232, 233 and 234) are sufficiently described by referring to the internal elements of signal conversion unit 240 (elements 241, 242, 243 and 244) as described above.

The data may be transmitted/received through the optical medium 250 (e.g., an optical fiber or an optical waveguide) according to, for example the SATA standards, and the control unit 210 and one or more signal conversion units 220-240 may use, for example a WDM technique to transmit/receive data.

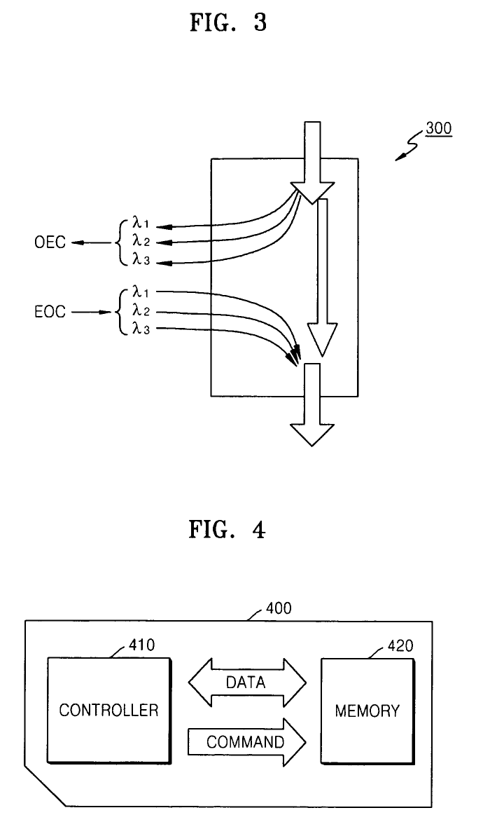

FIG. 3 illustrates the Optical Add/Drop Multiplexer (OADM) of FIG. 2. Referring to FIG. 3, an OADM 300 may perform three operations. One, the OADM 300 may bypass data transferred from the top to the bottom. Two, the OADM 300 may transfer an optical signal (e.g. λ₁, λ₂, and λ₃) received from the top, to an optical-to-electrical signal converter (OEC). Three, the OADM 300 may transfer data (e.g. λ₁, λ₂, and λ₃), received from an electrical-to-optical signal converter (EOC), to the bottom.

FIG. 4 is a schematic diagram illustrating a memory card 400 according to example embodiments. Referring to FIG. 4, a controller 410 and a memory 420 may exchange electric signals. For example, according to commands of the controller 410, the memory 420 and the controller 410 may exchange data. Accordingly, the memory card 400 may either store data in the memory 420 or output data from the memory 420. The memory 420 may include one of the solid state drive memory devices described above in reference to FIGS. 1 through 3.

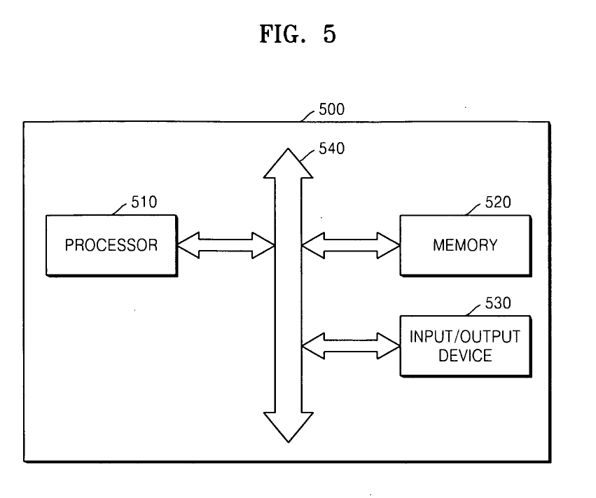

FIG. 5 is a block diagram roughly illustrating an electronic system 500 according to example embodiments. Referring to FIG. 5, a processor 510, an input/output device 530, and a memory 520 may perform data communication with each other by using a bus 540. The processor 510 may execute a program and control the electronic system 500. The input/output device 530 may be used to input/output data to/from the electronic system 500. The electronic system 500 may be connected to an external device, e.g. a personal computer or a network, by using the input/output device 530 and may exchange data with the external device.

The memory 520 may store codes or programs for operations of the processor 510. For example, the memory 520 may include one of the solid state drive memory devices described above in reference to FIGS. 1 through 3.

For example, such an electronic system 500 may embody various electronic control systems requiring the memory 520, and, for example, may be used in mobile phones, MP3 players, navigation devices, or household appliances.

While example embodiments of the inventive concept have been particularly shown and described, it will be understood by one of ordinary skill in the art that various changes in form and detail may be made therein without departing from the spirit and scope of the following claims.

What is claimed is:

1. An optical system comprising:
a solid state drive (SSD) module including a plurality of solid state memory units; and
an input/output (I/O) interface configured to receive data to be written to at least one of the solid state memory units from a main memory unit, the input/output (I/O) interface configured to transmit data written in at least one of the solid state memory units to the main memory unit, wherein the SSD module and the I/O interface transmit and receive data by using an optical medium.

2. The optical system of claim 1, wherein
the SSD module includes,
an SSD control unit, and
a first conversion unit configured to,
convert a first differential electrical signal, received from the SSD control unit, into a first optical signal prior to transmission to the optical medium, and
convert a second optical signal, received from the optical medium, into a second differential electrical signal prior to transfer to the SSD control unit; and
the I/O interface includes,
an I/O control unit, and
a second conversion unit configured to,
convert a second differential electrical signal, received from the main control unit, into the second optical signal prior to transmission to the optical medium, and
convert the first optical signal, received from the optical medium, into a first differential electrical signal prior to transfer to the main control unit.

3. The optical system of claim 2, wherein
the first conversion unit includes,
a first electrical signal convertor converting the first differential electrical signal into a first electrical signal,
a first electrical-to-optical signal converter configured to convert the first electrical signal into the first optical signal,
a first switch configured to transfer the first optical signal to the optical medium and to receive the second optical signal,
a first optical-to-electrical signal converter configured to convert the second optical signal into a second electrical signal, and
a second electrical signal convertor configured to convert the second electrical signal into the second differential electrical signal, and
the second conversion unit includes,
a third electrical signal convertor configured to convert the second differential electrical signal into a second electrical signal,
a second electrical-to-optical signal converter configured to convert the second electrical signal into the second optical signal,
a second switch configured to transfer the second optical signal to the optical medium and to receive the first optical signal,
a second optical-to-electrical signal converter configured to convert the first optical signal into the first electrical signal, and
a fourth electrical signal convertor configured to convert the first electrical signal into the first differential electrical signal.

4. The optical system of claim 3, wherein
the first electrical-to-optical signal converter and the second electrical-to-optical signal converter are photo detectors, and
the first optical-to-electrical signal converter and the second optical-to-electrical signal converter are laser diodes.

5. The optical system of claim 1, wherein data is transmitted and received via the optical medium according to the Serial Advanced Technology Attachment (SATA) standard.

6. The optical system of claim 5, wherein the SSD module and the I/O interface transmit and receive data according to a Wavelength Division Multiplexing (WDM) technique.

7. The optical system of claim 1, wherein the optical medium is one of an optical fiber and an optical waveguide.

8. A system, comprising:
a processor;
a memory, the memory including the optical system of claim 1; and
a communication bus configured to communicatively connect the processor and the memory.

9. A solid state drive (SSD) module comprising:
a plurality of solid state memory units;
a control unit configured to control the solid state memory units; and
at least one signal conversion unit, wherein
the control unit and the signal conversion unit are connected via an optical medium, and
the signal conversion unit is configured to one of
convert an optical signal, received from the control unit via the optical medium, into an electrical signal prior to transfer to the solid state memory units,
convert an electrical signal, received from the solid state memory units, into an optical signal prior to transfer to the control unit via the optical medium, and
transfer an optical signal through the signal conversion unit.

10. The SSD module of claim 9, wherein the signal conversion unit comprises:
an electrical signal switch configured to select one of a first signal stored in the solid state memory units and a second signal to be stored in the solid state memory unit;
an electrical-to-optical signal converter configured to convert the voltage-type or current-type first signal into a light-type first optical signal; and
an optical signal switch configured to one of
transfer the first optical signal to the optical medium,
receive a second optical signal from the optical medium, and
transfer an optical signal through the optical signal switch.

11. The SSD module of claim 10, wherein the optical signal switch is an Optical Add/Drop Multiplexer (OADM).

12. The SSD module of claim 9, wherein
data is transmitted and received via the optical medium according to the Serial Advanced Technology Attachment (SATA) standard, and
the control unit and the signal conversion unit transmit and receive data according to a Wavelength Division Multiplexing (WDM) technique.

13. The optical system of claim 9, wherein the optical medium is one of an optical fiber and an optical waveguide.

14. A control unit, comprising:
a first converter configured to convert a first differential signal into a first electrical signal;
a second converter configured to convert the first electrical signal into a first optical signal;
a switch configured to transfer the first optical signal to an optical medium and configured to receive a second optical signal from the optical medium;
a third converter configured to convert the second optical signal into a second electrical signal; and
a fourth converter configured to convert the second electrical signal into a second differential signal.

15. The control unit of claim 14, comprising:
a control unit configured to read the first differential signal from a solid state memory and configured to write the second differential signal to the solid state memory.

16. The control unit of claim 14, comprising:
a control unit configured to receive the first differential signal from a main memory controller and configured to transmit the second differential signal to the main memory controller.

17. The control unit of claim 14, wherein the optical medium is one of an optical fiber and an optical waveguide.

18. The control unit of claim 14,
the second converter is a photo detector, and
the third converter is a laser diode.
